(19) United States
(12) Patent Application Publication
(10) Pub. No.: US 2009/0169949 A1
(43) Pub. Date: Jul. 2, 2009

(54) ELECTRODE INKS CONTAINING COALESCING SOLVENTS

(75) Inventors: Michael T. HICKS, Bend, OR (US); Steven J. HAMROCK, Stillwater, MN (US); Eric J. HANSON, Hudson, WI (US); Theresa M. WATSCHKE, Saint Paul, MN (US); Mark S. SCHABERG, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/342,634

(22) Filed: Dec. 23, 2008

Related U.S. Application Data
(60) Provisional application No. 61/017,061, filed on Dec. 27, 2007.

(51) Int. Cl. H01M 8/10; H01M 4/90; B05D 5/12

(52) U.S. Cl. 429/30; 429/42; 427/115

(57) ABSTRACT

A catalyst ink is provided comprising: a) solids, comprising: i) a catalyst material, and ii) a polymer electrolyte; b) an aqueous solvent; and c) a coalescing solvent. In some embodiments, the coalescing solvent is selected from the group consisting of alkanes, alkenes, amines, ethers, and aromatic compounds which may optionally be substituted. In some embodiments, the coalescing solvent is selected from the group consisting of partially fluorinated alkanes, partially fluorinated tertiary amines, fully fluorinated alkanes and fully fluorinated tertiary amines. In another aspect, the present disclosure provides a fuel cell membrane electrode assembly comprising a catalyst layer comprising a coalescing solvent. In another aspect, the present disclosure provides a method of making a fuel cell membrane electrode assembly comprising a step of applying a catalyst ink according to the present disclosure to one or more of: a) a polymer electrolyte membrane, and b) a porous, electrically conductive gas diffusion layer.

### CROSS REFERENCE TO RELATED APPLICATION

This application claims the benefit of U.S. Provisional Patent Application No. 61/017,061, filed Dec. 27, 2007, the disclosure of which is incorporated by reference herein in its entirety.

### FIELD OF THE DISCLOSURE

This disclosure relates to methods of making fuel cell membrane electrode assemblies using electrode inks containing coalescing solvents.

### SUMMARY OF THE INVENTION

Briefly, the present disclosure provides a catalyst ink comprising: a) solids, comprising: i) a catalyst material, and ii) a polymer electrolyte; b) an aqueous solvent; and c) a coalescing solvent. In some embodiments, the coalescing solvent is selected from the group consisting of alkanes, alkenes, amines, ethers, and aromatic compounds which may optionally be substituted. In some embodiments, the coalescing solvent is selected from the group consisting of partially fluorinated alkanes, partially fluorinated tertiary amines, fully fluorinated alkanes and fully fluorinated tertiary amines. The catalyst ink typically comprises 5-30% by weight of solids, more typically 10-20% by weight of solids. The aqueous solvent typically comprises 0-50% alcohols, 0-20% polyalcohols, and 30-100% water. The catalyst ink typically comprises 5-25% by weight of coalescing solvent, more typically 10-20% by weight of coalescing solvent, and in some embodiments about 15% by weight of coalescing solvent.

In another aspect, the present disclosure provides a fuel cell membrane electrode assembly comprising a catalyst layer comprising a coalescing solvent. In some embodiments, the coalescing solvent is selected from the group consisting of alkanes, alkenes, amines, ethers, and aromatic compounds which may optionally be substituted. In some embodiments, the coalescing solvent is selected from the group consisting of partially fluorinated alkanes, partially fluorinated tertiary amines, fully fluorinated alkanes and fully fluorinated tertiary amines.

In another aspect, the present disclosure provides a method of making a fuel cell membrane electrode assembly comprising a step of applying a catalyst ink according to the present disclosure to one or more of: a) a polymer electrolyte membrane, and b) a porous, electrically conductive gas diffusion layer.

In this application:

“uniform” distribution of an additive in a polymer membrane means that the amount of additive present does not vary more than +/−90%, more typically not more than +/−50% and more typically not more than +/−20%;

“equivalent weight” (EW) of a polymer means the weight of polymer which will neutralize one equivalent of base;

“polyvalent cation” means a cation having a charge of 2+ or greater;

“highly fluorinated” means containing fluorine in an amount of 40 wt % or more, typically 50 wt % or more and more typically 60 wt % or more; and

“acid form” means, with regard to an anionic functional group, that it is neutralized by a proton.

“substituted” means, for a chemical species, substituted by conventional substituents which do not interfere with the desired product or process, e.g., substituents can be alkyl, alkoxy, aryl, phenyl, halo (F, Cl, Br, I), cyano, nitro, etc.

### BRIEF DESCRIPTION OF THE DRAWING

FIG. 1 is a graph presenting GDS Performance for 7 membrane electrode assemblies (MEA's) according to the present disclosure and one comparative MEA, as discussed in the Examples.

FIG. 2 is a graph presenting Air Utilization Performance for 7 membrane electrode assemblies (MEA's) according to the present disclosure and one comparative MEA, as discussed in the Examples.

### DETAILED DESCRIPTION

The present disclosure provides methods of making fuel cell electrodes, and membrane electrode assemblies (MEA's) comprising such electrodes, which demonstrate improved coating uniformity and improved fuel cell performance.

A membrane electrode assembly (MEA) or polymer electrolyte membrane (PEM) according to the present disclosure may be useful in electrochemical cell such as a fuel cell. An MEA is the central element of a proton exchange membrane fuel cell, such as a hydrogen fuel cell. Fuel cells are electrochemical cells which produce usable electricity by the catalyzed combination of a fuel such as hydrogen and an oxidant such as oxygen. Typical MEA's comprise a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. In typical use, protons are formed at the anode via hydrogen oxidation and transported across the PEM to the cathode to react with oxygen, causing electrical current to flow in an external circuit connecting the electrodes. Each electrode layer includes electrochemical catalysts, typically including platinum metal. The PEM forms a durable, non-porous, electrically non-conductive mechanical barrier between the reactant gases, yet it also passes H⁺ ions readily. Gas diffusion layers (GDL's) facilitate gas transport to and from the anode and cathode electrode materials and conduct electrical current. The GDL is both porous and electrically conductive, and is typically composed of carbon fibers. The GDL may also be called a fluid transport layer (FTL) or a diffuser/current collector (DCC). In some embodiments, the anode and cathode electrode layers are applied to GDL's to form catalyst coated backing layers (CCB's) and the resulting CCB's sandwiched with a PEM to form a five-layer MEA. The five layers of a five-layer MEA are, in order: anode GDL, anode electrode layer, PEM, cathode electrode layer, and cathode GDL. In other embodiments, the anode and cathode electrode layers are applied to either side of the PEM, and the resulting catalyst-coated membrane (CCM) is sandwiched between two GDL's to form a five-layer MEA.

The PEM according to the present disclosure may comprise any suitable polymer electrolyte. The polymer electrolytes useful in the present disclosure typically bear anionic functional groups bound to a common backbone, which are typically sulfonic acid groups but may also include carboxylic acid groups, imide groups, amide groups, or other acidic functional groups. The polymer electrolytes useful in the present disclosure are highly fluorinated and most typically perfluorinated. The polymer electrolytes useful in the present disclosure are typically copolymers of tetrafluoroethylene and one or more fluorinated, acid-functional comonomers. Typical polymer electrolytes include Nafion™ (DuPont Chemicals, Wilmington Del.) and Flemion™ (Asahi Glass Co. Ltd., Tokyo, Japan). The polymer electrolyte may be a copolymer of tetrafluoroethylene (TFE) and FSO₂—CF₂CF₂CF₂CF₂—O—CF═CF₂, described in U.S. patent application Ser. Nos. 10/322,254, 10/322,226 and 10/325,278, which are incorporated herein by reference. The polymer typically has an equivalent weight (EW) of 1200 or less and more typically 1100 or less. In some embodiments, polymers of unusually low EW can be used, typically 1000 or less, more typically 900 or less, and more typically 800 or less, often with improved performance in comparison to the use of higher EW polymer.

The polymer can be formed into a membrane by any suitable method. The polymer is typically cast from a suspension. Any suitable casting method may be used, including bar coating, spray coating, slit coating, brush coating, and the like. After forming, the membrane may be annealed, typically at a temperature of 120° C. or higher, more typically 130° C. or higher, most typically 150° C. or higher. The PEM typically has a thickness of less than 50 microns, more typically less than 40 microns, more typically less than 30 microns, and most typically about 25 microns.

In some embodiments of the present disclosure, one or more cerium or manganese compounds in solution or suspension may be added to the polymer electrolyte or membrane before, during, or after membrane formation, as disclosed in U.S. Pat. App. Pub. Nos. 2006/0063054 A1 and 2006/0063055 A1 and U.S. patent application Ser. Nos. 11/261,053, 11/262,268 and (Atty. Docket No. 61757US005), incorporated herein by reference.

A PEM according to the present disclosure may additionally comprise a porous support, such as a layer of expanded PTFE or the like, where the pores of the porous support contain the polymer electrolyte. A PEM according to the present disclosure may comprise no porous support. A PEM according to the present disclosure may comprise a crosslinked polymer.

Any suitable GDL may be used in the practice of the present disclosure. Typically the GDL is comprised of sheet material comprising carbon fibers. Typically the GDL is a carbon fiber construction selected from woven and non-woven carbon fiber constructions. Carbon fiber constructions which may be useful in the practice of the present disclosure may include: Toray™ Carbon Paper, SpectraCarb™ Carbon Paper, AFN™ non-woven carbon cloth, Zoltek™ Carbon Cloth, and the like. The GDL may be coated or impregnated with various materials, including carbon particle coatings, hydrophilizing treatments, and hydrophobizing treatments such as coating with polytetrafluoroethylene (PTFE).

To make a CCM, catalyst ink may be applied to the PEM by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

To make a CCB, catalyst ink may be applied to the GDL by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

Any suitable catalyst may be used in the practice of the present disclosure. Typically, carbon-supported catalyst particles are used. Typical carbon-supported catalyst particles are 50-90% carbon and 10-50% catalyst metal by weight, the catalyst metal typically comprising Pt for the cathode and Pt and Ru in a weight ratio of 2:1 for the anode.

Typically, the catalyst is applied to the PEM or to the FTL in the form of a catalyst ink. Alternately, the catalyst ink may be applied to a transfer substrate, dried, and thereafter applied to the PEM or to the FTL as a decal. In some embodiments, the ink may be applied in multiple layers, with each layer having the same composition or with some layers having differing compositions. The catalyst ink typically comprises polymer electrolyte material, which may or may not be the same polymer electrolyte material which comprises the PEM. The catalyst ink typically comprises a dispersion of catalyst particles in a dispersion of the polymer electrolyte. The ink typically contains 5-30% solids (i.e. polymer and catalyst) and more typically 10-20% solids. The electrolyte dispersion is typically an aqueous dispersion, which may additionally contain alcohols and polyalcohols such a glycerin and ethylene glycol. The water, alcohol, and polyalcohol content may be adjusted to alter rheological properties of the ink. The ink typically contains 0-50% alcohol and 0-20% polyalcohol. In addition, the ink may contain 0-2% of a suitable dispersant. The ink is typically made by stirring with heat followed by dilution to a coatable consistency.

The catalyst ink according to the present disclosure additionally comprises a coalescing solvent. Useful coalescing solvents typically have a good affinity for the polymer electrolyte included in the ink, which may be demonstrated by the ability of the solvent to swell the polymer. Useful coalescing solvents typically act to soften or plasticize the polymer electrolyte. Useful coalescing solvents typically act to lower the Tg of the polymer electrolyte. Useful coalescing solvents typically allow the polymer electrolyte to form a film at lower temperatures. Where the polymer electrolyte included in the ink is highly fluorinated or perfluorinated, useful coalescing solvents may be fluorinated as well. Where the polymer electrolyte included in the ink is highly fluorinated or perfluorinated, useful coalescing solvents may be highly fluorinated or perfluorinated. Useful coalescing solvents are typically higher boiling compounds, typically having a boiling point greater than 90° C., more typically having a boiling point greater than 95° C., more typically having a boiling point greater than 100° C., more typically having a boiling point greater than 110° C., more typically having a boiling point greater than 120° C. Useful coalescing solvents typically are poorly soluble in water. Useful coalescing solvents may include alkanes, alkenes, amines, ethers, or aromatic compounds which may optionally be substituted. Useful coalescing solvents may include partially, highly or fully fluorinated alkanes, alkenes, amines, ethers, or aromatic compounds which may optionally be substituted. Useful coalescing solvents may include partially or fully fluorinated alkanes or tertiary amines such as 3M™ Novec™ or Fluorinert™ Fluids, available from 3M Company, St. Paul, Minn.

In some embodiments, the ink according to the present disclosure contains 1-50% by weight coalescing solvents. In some embodiments, the ink according to the present disclosure contains 1-40% by weight coalescing solvents. In some embodiments, the ink according to the present disclosure contains 1-35% by weight coalescing solvents. In some embodiments, the ink according to the present disclosure contains 1-30% by weight coalescing solvents. In some embodiments, the ink according to the present disclosure contains 1-25% by weight coalescing solvents. In some embodiments, the ink according to the present disclosure contains 1-20% by weight coalescing solvents. In some embodiments, the ink according to the present disclosure contains 5-25% by weight coalescing solvents. In some embodiments, the ink according to the present disclosure contains 10-20% by weight coalescing solvents.

Without wishing to be bound by theory, applicants believe that the addition of a coalescing solvent or coalescing additive according to the method of the present disclosure improves coating uniformity by reducing defects such a mud cracks, de-wets and voids. It is believed that such defects are primarily due to the inability of the ionomer in the ink to form a film during drying. The addition of coalescing additives according to the present disclosure is believed to improve the film forming properties of the ionomer thereby reducing coating defects and improving yields.

In some embodiments of the present disclosure, one or more cerium or manganese compounds in solution or suspension may be added to the catalyst ink before, during, or after MEA manufacture.

In some embodiments of the present disclosure, a PEM may be formed, cast or extruded from a suspension or solution which includes a coalescing solvent or coalescing additive according to the present disclosure.

To make an MEA, GDL's may be applied to either side of a CCM by any suitable means. Alternately, CCB's may be applied to either side of a PEM by any suitable means.

In use, the MEA according to the present typically sandwiched between two rigid plates, known as distribution plates, also known as bipolar plates (BPP's) or monopolar plates. Like the GDL, the distribution plate must be electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, the distribution plate may have channels on one side only, to distribute fluids to or from an MEA on only that side, which may be termed a “monopolar plate.” The term bipolar plate, as used in the art, typically encompasses monopolar plates as well. A typical fuel cell stack comprises a number of MEA's stacked alternately with bipolar plates.

This disclosure is useful in the manufacture and operation of fuel cells.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

The following experiments compare the performance of a comparative MEA made with an electrode ink without coalescing additive to MEA's made with electrode inks containing coalescing additives.

### Example 1

### Comparative

### Baseline Catalyst Ink (No Coalescing Additives)

60.0 g of NECC SA50BK supported catalyst (50% Pt/C, lot SOC00195) was placed in a beaker. 214.5 g of 11% solids solution of Nafion® (3M ID 11-0021-3501-7, lot SGW 06-07CS) was added to the beaker and mixed with the catalyst powder. 267.5 g of water was added to the beaker and mixed with the catalyst powder/ionomer solution. The ink mixture was then placed upon a heated stirring plate for 1 hour. The hot plate was set to 100° C. and the magnetic stirrer was turned on. A watch glass was placed over the beaker. After the heating the catalyst ink, it was allowed to cool for 10 minutes. A VirTis Handishear at the level 3 setting was used to disperse the ink. The ink was allowed to cool to room temperature prior to coating. The ink was given the identification of CIF07.

### Example 2

### FC-3283 (Perfluoro Ether Additive) Catalyst Ink

6 g of NECC SA50BK supported catalyst (50% Pt/C, lot SOC00195) was placed in a beaker. 21.2 g of 11% solids solution of Nafion® (3M ID 11-0021-3501-7, lot SGW 06-07CS) was added to the beaker and mixed with the catalyst powder. 26.5 g of water was added to the beaker and mixed with the catalyst powder/ionomer solution. The ink mixture was then placed upon a heated stirring plate for 1 hour. The hot plate was set to 100° C. and the magnetic stirrer was turned on. A watch glass was placed over the beaker. After the heating the catalyst ink, it was allowed to cool for 10 minutes. 9.5 g of 3M™ Fluorinert™ Electronic Liquid FC-3283 (3M Company, St. Paul, Minn., USA) was added to the ink. A VirTis Handishear at the level 3 setting was used to disperse the ink and the coalescing additive. The ink was allowed to cool to room temperature prior to coating. The ink was given the identification of EC07FXL002S.

### Example 3

### FC-77 (Perfluoro Octane Additive) Catalyst Ink

6 g of NECC SA50BK supported catalyst (50% Pt/C, lot SOC00195) was placed in a beaker. 21.2 g of 11% solids solution of Nafion® (3M ID 11-0021-3501-7, lot SGW 06-07CS) was added to the beaker and mixed with the catalyst powder. 26.5 g of water was added to the beaker and mixed with the catalyst powder/ionomer solution. The ink mixture was then placed upon a heated stirring plate for 1 hour. The hot plate was set to 100° C. and the magnetic stirrer was turned on. A watch glass was placed over the beaker. After the heating the catalyst ink, it was allowed to cool for 10 minutes. 9.5 g of 3M™ Fluorinert™ Electronic Liquid FC-77 (3M Company, St. Paul, Minn., USA) was added to the ink. A VirTis Handishear at the level 3 setting was used to disperse the ink and the coalescing additive. The ink was allowed to cool to room temperature prior to coating. The ink was given the identification of EC07FXL004S.

### Example 4

### FC-40 (Perfluorotributyl Amine Additive) Catalyst Ink

6 g of NECC SA50BK supported catalyst (50% Pt/C, lot SOC00195) was placed in a beaker. 21.2 g of 11% solids solution of Nafion® (3M ID 11-0021-3501-7, lot SGW 06-07CS) was added to the beaker and mixed with the catalyst powder. 26.5 g of water was added to the beaker and mixed with the catalyst powder/ionomer solution. The ink mixture was then placed upon a heated stirring plate for 1 hour. The hot plate was set to 100° C. and the magnetic stirrer was turned on. A watch glass was placed over the beaker. After the heating the catalyst ink, it was allowed to cool for 10 minutes. 9.5 g of 3M™ Fluorinert™ Electronic Liquid FC-40 (3M Company, St. Paul, Minn., USA) was added to the ink. A VirTis Handishear at the level 3 setting was used to disperse the ink and the coalescing additive. The ink was allowed to cool to room temperature prior to coating. The ink was given the identification of EC07FXL005S.

### Example 5

### FC-70 (Perfluorotriamyl Amine Additive) Catalyst Ink

6 g of NECC SA50BK supported catalyst (50% Pt/C, lot SOC00195) was placed in a beaker. 21.2 g of 11% solids solution of Nafion® (3M ID 11-0021-3501-7, lot SGW 06-07CS) was added to the beaker and mixed with the catalyst powder. 26.5 g of water was added to the beaker and mixed with the catalyst powder/ionomer solution. The ink mixture was then placed upon a heated stirring plate for 1 hour. The hot plate was set to 100° C. and the magnetic stirrer was turned on. A watch glass was placed over the beaker. After the heating the catalyst ink, it was allowed to cool for 10 minutes. 9.5 g of 3M™ Fluorinert™ Electronic Liquid FC-70 (3M Company, St. Paul, Minn., USA) was added to the ink. A VirTis Handishear at the level 3 setting was used to disperse the ink and the coalescing additive. The ink was allowed to cool to room temperature prior to coating. The ink was given the identification of EC07FXL006S.

### Example 6

### Novec 7500 Catalyst Ink

6 g of NECC SA50BK supported catalyst (50% Pt/C, lot SOC00195) was placed in a beaker. 21.2 g of 11% solids solution of Nafion® (3M ID 11-0021-3501-7, lot SGW 06-07CS) was added to the beaker and mixed with the catalyst powder. 26.5 g of water was added to the beaker and mixed with the catalyst powder/ionomer solution. The ink mixture was then placed upon a heated stirring plate for 1 hour. The hot plate was set to 100° C. and the magnetic stirrer was turned on. A watch glass was placed over the beaker. After the heating the catalyst ink, it was allowed to cool for 10 minutes. 9.5 g of Novec 7500 was added to the ink. A VirTis Handishear at the level 3 setting was used to disperse the ink and the coalescing additive. The ink was allowed to cool to room temperature prior to coating. The ink was given the identification of EC07FXL001S.

### Example 7

### Novec 7300 Catalyst Ink

6 g of NECC SA50BK supported catalyst (50% Pt/C, lot SOC00195) was placed in a beaker. 21.2 g of 11% solids solution of Nafion® (3M ID 11-0021-3501-7, lot SGW 06-07CS) was added to the beaker and mixed with the catalyst powder. 26.5 g of water was added to the beaker and mixed with the catalyst powder/ionomer solution. The ink mixture was then placed upon a heated stirring plate for 1 hour. The hot plate was set to 100° C. and the magnetic stirrer was turned on. A watch glass was placed over the beaker. After the heating the catalyst ink, it was allowed to cool for 10 minutes. 9.5 g of Novec 7300 was added to the ink. A VirTis Handishear at the level 3 setting was used to disperse the ink and the coalescing additive. The ink was allowed to cool to room temperature prior to coating. The ink was given the identification of EC07FXL003S.

### Example 8

### Propylene Glycol Butyl Ether (PGBE, Aldrich) Catalyst Ink

6 g of NECC SA50BK supported catalyst (50% Pt/C, lot SOC00195) was placed in a beaker. 21.2 g of 11% solids solution of Nafion® (3M ID 11-0021-3501-7, lot SGW 06-07CS) was added to the beaker and mixed with the catalyst powder. 26.5 g of water was added to the beaker and mixed with the catalyst powder/ionomer solution. The ink mixture was then placed upon a heated stirring plate for 1 hour. The hot plate was set to 100° C. and the magnetic stirrer was turned on. A watch glass was placed over the beaker. After the heating the catalyst ink, it was allowed to cool for 10 minutes. 6.0 g of PGBE was added to the ink. A VirTis Handishear at the level 3 setting was used to disperse the ink and the coalescing additive. The ink was allowed to cool to room temperature prior to coating. The ink was given the identification of EC07FXL007S.

MEA's were made from the inks described above using the following procedure. Electrode E452-6073L was used as the anode for all MEA's. E452-6073L is a standard catalyst coating backing (CCB) using a 2950 gas diffusion layer. For the cathodes, the inks in Examples 1 to 8 were hand brushed onto PTFE-treated carbon paper gas diffusion layers. Multiple coatings were needed to reach the 0.4 mg Pt/cm² target loading. After the target loading was reached, the electrodes were dried in a vacuum oven at 110° C. for 30 minutes to ensure no solvents remained. The anode and cathode electrodes were bonded to a Nafion membrane (lot TAM3M04092-1) by pressing in a Carver Press (Fred Carver Co., Wabash, Inn.) with 13.4 kN of force at 132° C. for 10 minutes with Teflon/glass gaskets. The thickness of the gaskets was 70% of the thickness of the CCB electrodes.

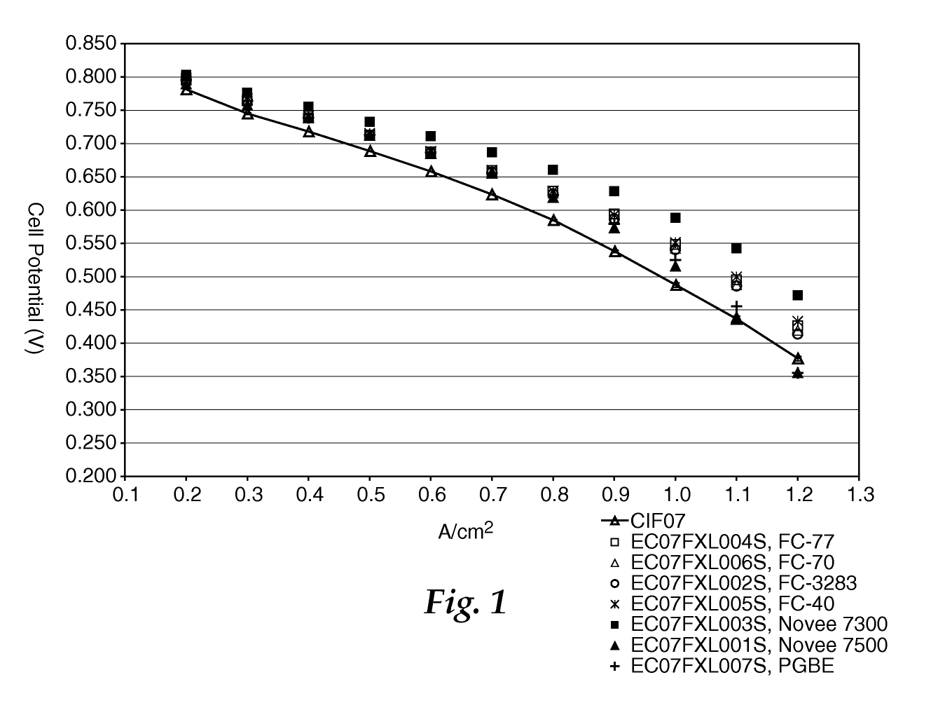

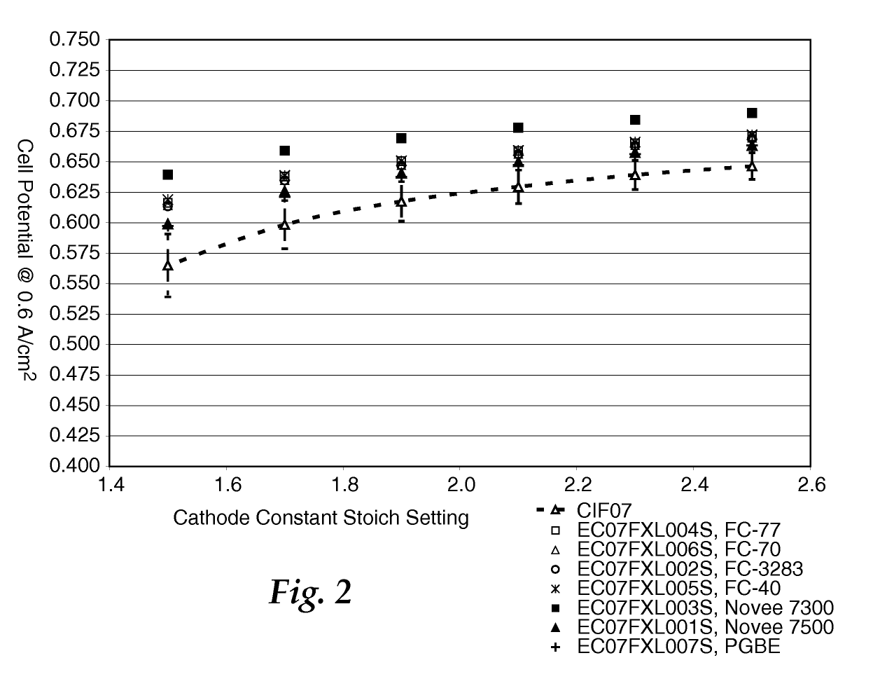

The MEA's were tested in a test station with independent controls of gas flow, pressure, relative humidity, and current or voltage (Fuel Cell Technologies, Albuquerque, N. Mex.). The test fixture included graphite current collector plates with quad-serpentine flow fields. All samples were tested under the “NP Residential H₂ Only” script. The script first equilibrates the MEA's under constant a flow of H₂/Air and then test the MEA's under a series of constant stoichiometry conditions. The results of the tests, shown in FIG. 1 (GDS Performance) and FIG. 2 (Air Utilization Performance), demonstrate superior performance for MEA's according to the present disclosure over the MEA of Comparative Example 1.

Various modifications and alterations of this disclosure will become apparent to those skilled in the art without departing from the scope and principles of this disclosure, and it should be understood that this disclosure is not to be unduly limited to the illustrative embodiments set forth hereinabove.

We claim:

1. A catalyst ink comprising:
a) solids comprising
i) a catalyst material; and
ii) a polymer electrolyte;
b) an aqueous solvent; and
c) a coalescing solvent.

2. The catalyst ink according to claim 1 wherein the coalescing solvent is selected from the group consisting of alkanes, alkenes, amines, ethers, and aromatic compounds which may optionally be substituted.

3. The catalyst ink according to claim 1 wherein the coalescing solvent is selected from the group consisting of partially fluorinated alkanes, partially fluorinated tertiary amines, fully fluorinated alkanes and fully fluorinated tertiary amines.

4. The catalyst ink according to claim 1 which comprises 5-30% by weight of solids.

5. The catalyst ink according to claim 1 which comprises 10-20% by weight of solids.

6. The catalyst ink according to claim 1 wherein the aqueous solvent comprises 0-50% alcohols, 0-20% polyalcohols, and 30-100% water.

7. The catalyst ink according to claim 1 which comprises 5-25% by weight of coalescing solvent.

8. The catalyst ink according to claim 1 which comprises 10-20% by weight of coalescing solvent.

9. The catalyst ink according to claim 1 which comprises about 15% by weight of coalescing solvent.

10. The catalyst ink according to claim 4 which comprises 5-25% by weight of coalescing solvent.

11. A fuel cell membrane electrode assembly comprising a catalyst layer comprising a coalescing solvent.

12. The fuel cell membrane electrode assembly according to claim 11 wherein the coalescing solvent is selected from the group consisting of alkanes, alkenes, amines, ethers, and aromatic compounds which may optionally be substituted.

13. The fuel cell membrane electrode assembly according to claim 11 wherein the coalescing solvent is selected from the group consisting of partially fluorinated alkanes, partially fluorinated tertiary amines, fully fluorinated alkanes and fully fluorinated tertiary amines.

14. A method of making a fuel cell membrane electrode assembly comprising a step of applying a catalyst ink according to claim 1 to one or more of:
a) a polymer electrolyte membrane, and
b) a porous, electrically conductive gas diffusion layer.

15. The method according to claim 14 comprising a step of applying a catalyst ink according to claim 1 to a polymer electrolyte membrane.

16. The method according to claim 14 comprising a step of applying a catalyst ink according to claim 1 to a porous, electrically conductive gas diffusion layer.
